(19) United States
(12) Patent Application Publication
(10) Pub. No.: US 2006/0184892 A1
(43) Pub. Date: Aug. 17, 2006

(54) Method and system providing for the compact navigation of a tree structure

(76) Inventor: Robert P. Morris, Raleigh, NC (US)

Correspondence Address: SCENERA RESEARCH, LLC, 111 Corning Road, Suite 220, Cary, NC, 27511, US

(21) Appl. No.: 11/061,918

(22) Filed: Feb. 17, 2005

(51) Int. Cl. G06F 9/00; G06F 3/00

(52) U.S. Cl. 715/767; 715/854; 715/853; 715/811; 715/821

(57) ABSTRACT

A method and system are described providing for the compact navigation of a tree structure. According to an exemplary embodiment, a path in the tree structure is displayed. A selection component is included in the displayed path to represent a level of the tree structure at which there exists a plurality of nodes. A selection of a node from among the nodes existing at the level of the tree structure represented by the selection component is allowed when the selection component has focus. Only a selected node is displayed when the selection component does not have focus. The method and system allow complex hierarchical data structures to be presented in a compact form appropriate for portable electronic devices having smaller-sized displays.

### BACKGROUND

Files and applications are typically organized on personal computers (PCs) and portable electronic devices in a hierarchical manner. Files, for example, can be organized into a hierarchical arrangement of folders and subfolders, while applications can include a hierarchical arrangement of menus and submenus for the various application functions. On PCs and other electronic devices having relatively large displays, browser applications, such as MICROSOFT™ WINDOWS™ EXPLORER™, can be used to efficiently view and navigate complex tree structures. These browser applications typically support non-linear navigation of hierarchical file structures, making it possible for users to jump between certain nodes and levels in the hierarchy without having to traverse through each node in the file structure between source and destination nodes. Similarly, complex application menu systems can be presented on larger displays in a tiled manner to aid users in navigating to the various menu functions.

Hierarchical data structures are typically presented on PC displays and portable electronic devices in tree, menu, or folder views. Tree and menu views can require a relatively large amount of display area to navigate to leaf nodes (for example, applications or files) in the tree structure. To reach a particular leaf node in the tree structure, users must expand each node in the branch that includes the node of interest. When expanded, each node in a complex branch of nodes is typically displayed tiled (not overlapping) with its parent and/or child node, requiring a relatively large amount of screen area to form the view. Moreover, tree and menu views that show a particular level of the hierarchy typically remain “open”, that is they continue to display all of the nodes at that hierarchical level, even after a user has navigated through the level to a node of interest. These open views can unnecessarily occupy display area that could otherwise be used to present additional information to a user.

In addition, navigating to peer or sibling nodes using a tree or menu view can be challenging. For example, to navigate from a node in a current branch of the tree structure to a new node included in a second branch of the tree structure, a user must first return to a node in the current branch that is shared with the second branch including the new node, then traverse through each node of the second branch to reach the new node. Performing these navigation operations can be challenging when only a portion of the tree view is displayed. Accordingly, using tree or menu views to present hierarchical data structures can be undesirable on portable electronic devices having smaller-sized displays.

Folder views can address some of the shortcomings of tree and menu views described above, but have their own disadvantages as well. With folder views, a path to a current node in a hierarchical data structure is typically displayed near a presentation of the contents of the current node. For example, the path can be displayed in a location bar of a graphics user interface (GUI) window near a content pane of the window that includes the contents of the current node. While folder views can be arranged to suit the form-factors of portable electronic devices having smaller-sized displays, they still typically can provide only a limited view of the entire contents of a hierarchical file structure on such devices. Thus, it remains a challenge to navigate between nodes in the hierarchy using folder views.

### SUMMARY

Accordingly, a method and system are disclosed providing for the compact navigation of a tree structure. According to an exemplary embodiment, a path in the tree structure is displayed. A selection component is included in the displayed path to represent a level in the tree structure at which there exists more than one node. A selection of a node from among the nodes existing at the level of the tree structure represented by the selection component is allowed when the selection component has focus. Only a selected node is displayed when the selection component does not have focus.

According to another exemplary embodiment, a system is described providing for the compact navigation of a tree structure. The exemplary system includes a display configured to display a path in the tree structure. A graphics subsystem is included and is coupled to the display. The graphics subsystem is configured to include a selection component in the displayed path to represent a level in the tree structure at which there exists more than one node. The graphics subsystem is also configured to allow a selection of a node from among the nodes existing at the level of the tree structure represented by the selection component when the selection component has focus. The graphics subsystem is further configured to display only the selected node when the selection component does not have focus. The exemplary system also includes an input subsystem coupled to the graphics subsystem. The input subsystem is configured to determine when the item is selected using the selection component and whether the selection component has focus.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flowchart illustrating a method providing for the compact navigation of a tree structure, according to an exemplary embodiment;

FIG. 2 illustrates a user interface having a displayed path presented in a location bar that includes a combo box to provide for the compact navigation of a tree structure;

FIG. 3 illustrates a user interface having a displayed path presented in a location bar that includes a spin box to provide for the compact navigation of a tree structure;

FIG. 4 illustrates a user interface having a displayed path presented in a content pane that includes a spin box to provide for the compact navigation of a tree structure;

FIG. 5 illustrates a user interface suitable for use with a portable electronic device having a displayed path presented in a location bar that includes a spin box to provide for the compact navigation of a tree structure;

FIG. 6 illustrates a user interface suitable for use with a portable electronic device having a displayed path presented in a content pane that includes a spin box to provide for the compact navigation of a tree structure;

FIGS. 7A-7F illustrate several embodiments including spin boxes and drop-down boxes suitable for providing a compact, menu-like user interface for the compact navigation of a tree structure; and

FIG. 8 illustrates a system providing for the compact navigation of a tree structure, according to an exemplary embodiment.

### DETAILED DESCRIPTION

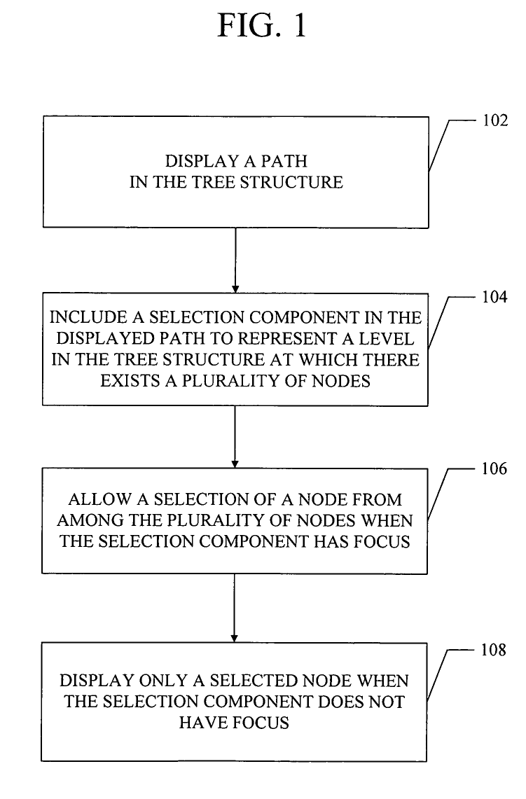

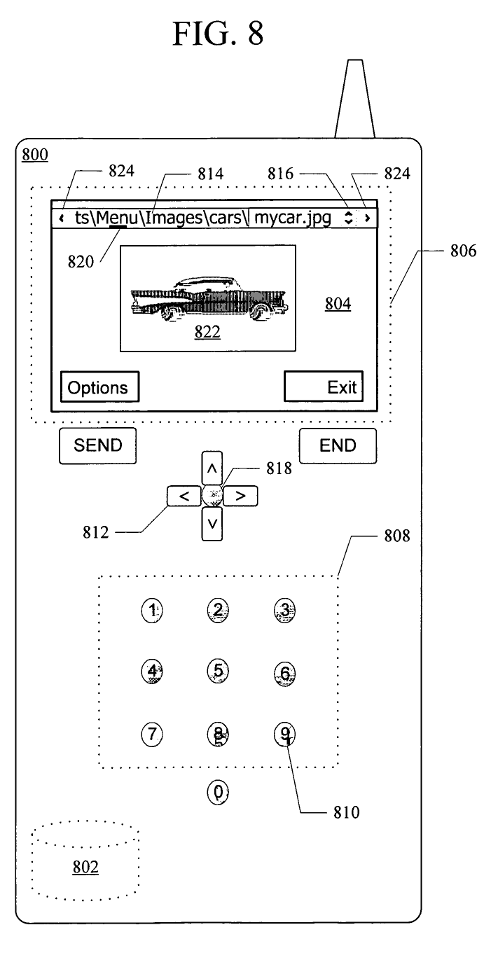

FIG. 1 is a flowchart illustrating a method for presenting information included in a tree structure according to an exemplary embodiment. The method can be carried out using the exemplary system depicted in FIG. 8, portions of which are referenced below for illustration purposes.

In the art of computer science, a tree is a widely-used computer data structure that emulates a tree structure with a set of linked nodes (see, e.g., WIKIPEDIA™ at “http://en.wikipedia.org/wiki/Tree_data_structure”; accessed on Jan. 28, 2005). Tree structures can be used to represent the objects included in a hierarchical data structure, with each node in the tree structure representing a corresponding object existing at particular level of the hierarchical data structure. The objects in a hierarchical data structure can represent files in a file system, images in an electronic photo album, menus and menu items in a hierarchical menu system of a GUI, and the like. A particular node can have zero or more child nodes (or children), where each child node represents an object in the data structure that is below the object represented by the particular node in the tree structure. In such arrangements, the particular node is referred to as a parent node of the child node. In tree structures, a child node is defined to have at least one parent node, and a node in the tree structure without a parent is called a root node (or root). Nodes with no children are referred to as leaf nodes. Nodes that exist at a same level of the tree structure are referred to as sibling nodes (or siblings).

Tree structures can be unordered, where no distinction is made between the various children of a node, for example, no child is identified as the “first child” or “last child”. A tree in which such distinctions are made is called an ordered tree, and the data structures built thereon are called ordered tree data structures. Unordered tree structures can be used to represent the files included in a file system or the images included in an electronic photo album, as such files or images need not be included in their respective data structures in any given order. Nevertheless, the identities of such files or images can be presented in an order, for example, alphanumerically, to improve the readability of the presented information.

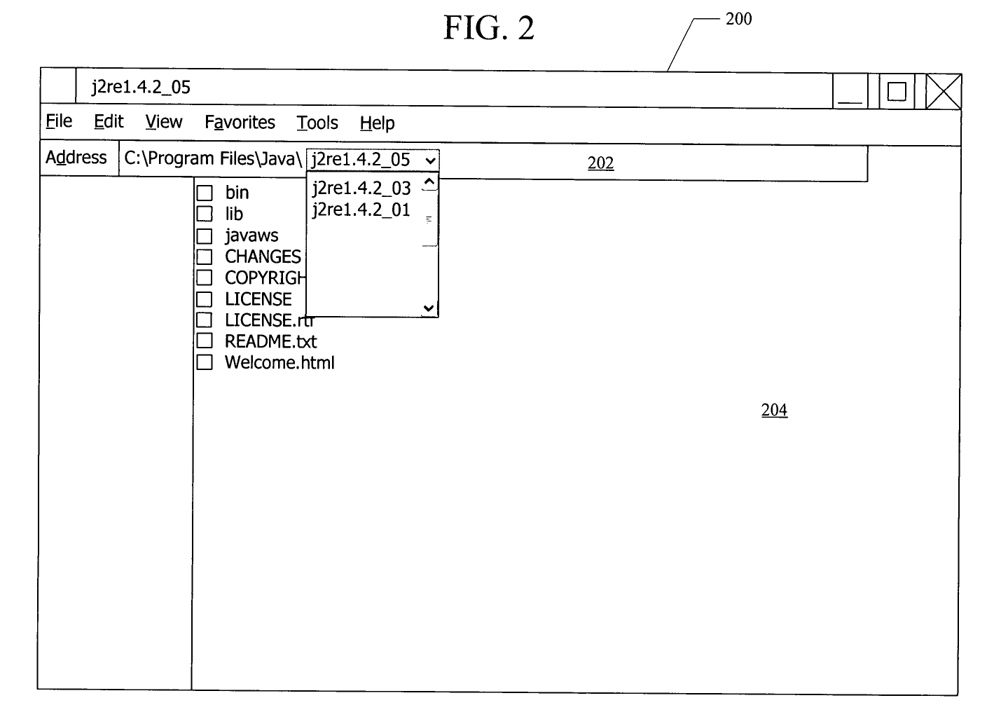

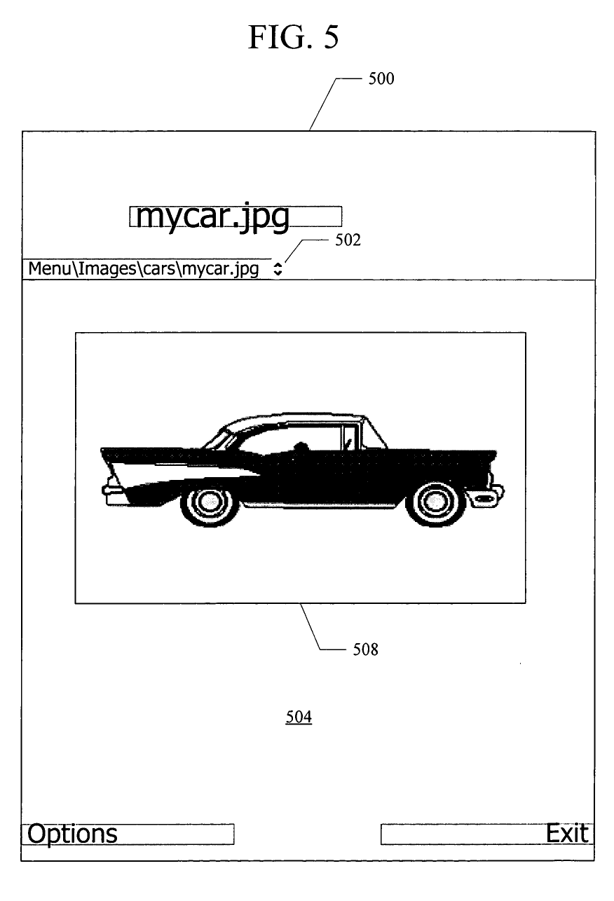

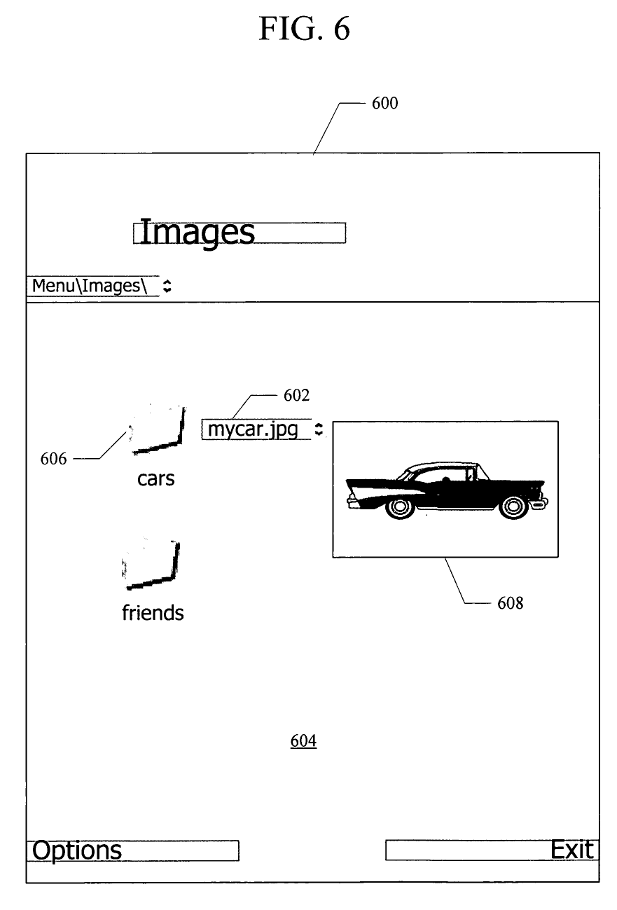

In block 102 of the method, a path in the tree structure is displayed. The path can be displayed on a monitor, such as an LCD or CRT display, of a computer or portable electronic device, such as a mobile phone, digital camera, camera phone, Personal Digital Assistant (PDA), and the like. The embodiments described here depict displaying the path using a computer monitor (FIGS. 2-4) and using a display of a digital camera or camera phone (FIGS. 5 and 6), but it will be understood that the techniques described here can be used with any suitable display device.

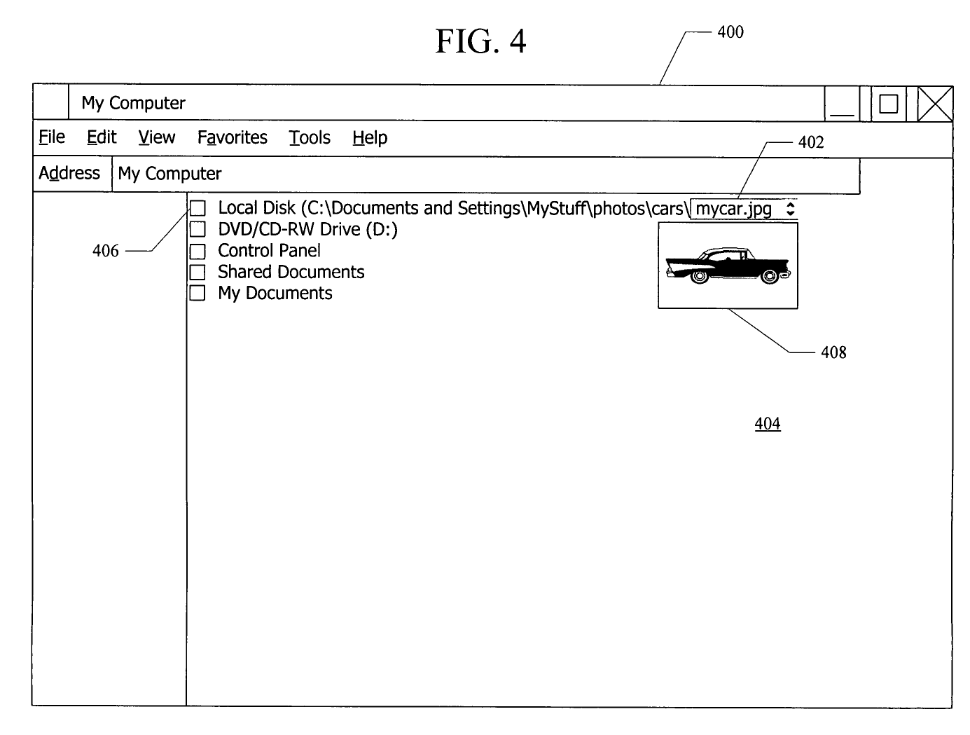

The path can be displayed as shown in FIG. 2 with identifiers, such as the terms “Program Files” and “Java”, being used to represent nodes in the tree structure. In that identifiers in path names can be used to represent nodes in the tree structure, the terms “identifier” and “node” are used interchangeably here. The displayed path can also include delimiters, such as a forward slash (“\”) or colon (“:”), used to demarcate the various levels at which the nodes included in the displayed path exist in the tree structure. The path can be displayed in a location bar 202, 505 of a GUI window 200, 500, as illustrated in FIGS. 2 and 5, or can be displayed as an identifier 402, 602 of an object 406, 606 included in a content pane 404, 604 of a GUI window 400, 600, as illustrated in FIGS. 4 and 6, but these examples are merely illustrative and should not be considered limiting in any way.

In block 104, a selection component is included in the displayed path to represent a level of the tree structure at which there exists more than one node. A selection component, as used here, includes any of the set of interactive components that can be used to interact with a GUI including, but not limited to, menus, controls, toolbars, and the like. GUIs typically include these interactive components to make it easier to carry out commands and specify values via the user interface. These components can also provide for a consistent structure and a set of interface conventions for exchanging information via the user interface. For examples of the types of selection components available through the MICROSOFT WINDOWS user interface, see chapter 7 of “Windows Interface Guidelines for Software Design”; Microsoft Press, ISBN 1-55615-679-0. It will be understood that the selection components of other user interfaces may be used with the techniques described here. Graphical techniques for including the selection component in the displayed path are beyond the scope of this document and need not be described here in detail, as these techniques are well understood by those skilled in the art of computer science.

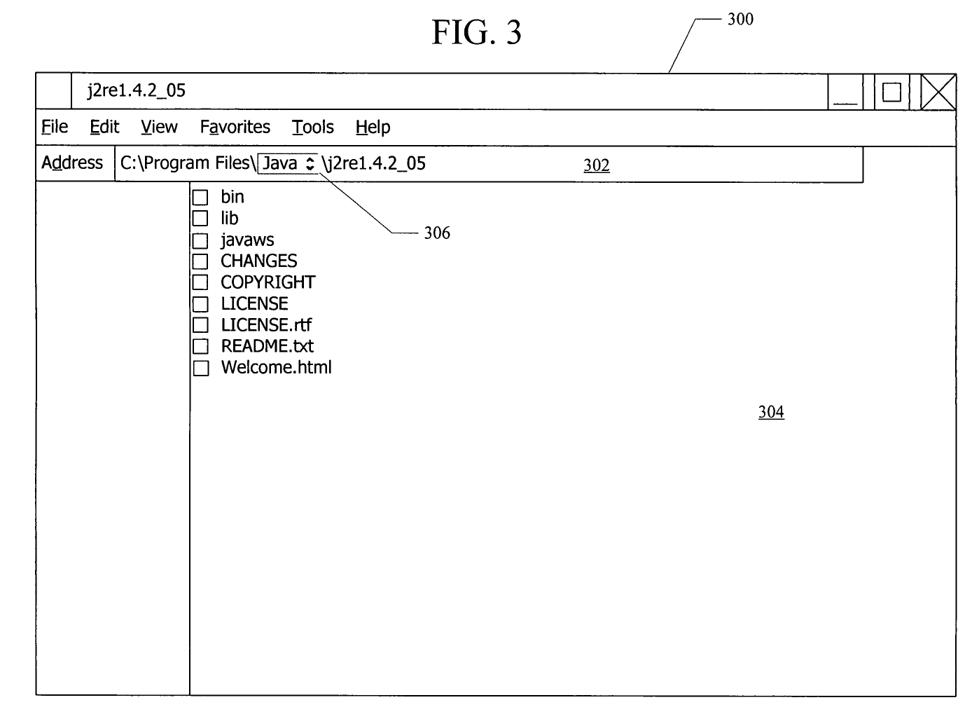

According to exemplary embodiments, the selection component included in the displayed path can include a drop-down combo box (“combo box”) control 206, as shown in FIG. 2, or a spin box control 306, as illustrated in FIG. 3. An advantage of including these selection components in the displayed path is that each of these particular controls allows a user to both type (or enter) text into the control and select from among a list of items included in the control using the available control buttons. Accordingly, these particular controls can allow a user to enter the text of a node of a path into a location bar 202 or an identifier 402 associated with an object 406 in much the same way that users are accustomed to entering path names into GUIs. Nevertheless, it will be understood that any appropriate selection components can be included in the displayed path. In that items included in a selection component can be used to represent nodes in the tree structure, the terms “item” and “node” are used interchangeably here.

As described above, the selection component is included in the displayed path to represent a level of the tree structure at which there exists more than one node. Consider, for example, that the path “C:\Program Files\Java” is displayed in the location bar 202 of the window 200 shown in FIG. 2. Each of the identifiers “C”, “Program Files”, and “Java” in the exemplary displayed path represent nodes in a tree structure. In this example, each of the nodes can correspond to a particular folder or file that exists at a respective level of a hierarchical file structure.

According to the method, a selection component is included in the displayed path to represent a level in the tree structure. In the example shown in FIG. 2, the combo box 206 can be included in the displayed path to represent the level of the hierarchy that includes the node “j2re1.4.2_{—}05”. The node “j2re1.4.2_{—}05” can correspond to a child of the node “Java” displayed in the path. For example, “j2re1.4.2_{—}05” can be a sub-directory of the directory “Java” in a hierarchical file structure. Similarly, the spin box 306 shown in FIG. 3 can be included in the path displayed in the location bar 302 to represent the level of the file hierarchy that includes the node “Java”.

Also in accordance with the method, the selection control is included in the displayed path to represent a level of the tree structure at which there exists more than one node. For example, the combo box 206 in FIG. 2 is included in the displayed path to represent a fourth level of the hierarchical file structure at which three nodes exist: “j2re1.4.2_{—}05”, “j2re1.4.2_{—}03”, and “j2re1.4.2_{—}01”. As described above, nodes that exist at a same level of a hierarchy are siblings. In this example, the nodes “j2re1.4.2_{—}05”, “j2re1.4.2_{—}03”, and “j2re1.4.2_{—}01” are siblings that can each be sub-directories of the common parent node “Java” that exists at a third level of the file structure hierarchy.

The inclusion of the selection component in the displayed path can occur in response to a selecting of a node displayed in the path. The selecting can occur, for example, using an input device such as a mouse, pointer, stylus, or keyboard. With such an arrangement, the selection component can be included in the displayed path by replacing an existing node in the path. For example, the node identifier “Java” shown in FIG. 2 could have been replaced by the spin box 306 shown in FIG. 3 in response to a user selecting the “Java” identifier of FIG. 2 with a mouse. Alternatively, the selection component can be included in the displayed path by appending the selection component to a node included in the displayed path. This alternative embodiment is described in greater detail below.

In block 106 of the method, a selection of a node from among the nodes existing at the level of the tree structure represented by the selection component is allowed when the selection component has focus. As used here, a component is said to have “focus” when the component is in a state of being capable of receiving input from an input device, such as a keyboard or a mouse. Similarly, a component that does not have focus is incapable of receiving input from an input device. It will be understood that in addition to components, any portion of a GUI (for example, windows) can be said to either have or not have focus.

For example, consider in FIG. 2 that the combo box 206 has focus. As described above, the open combo box 206 is shown to include three nodes: “j2re1.4.2_{—}05”, “j2re1.4.2_{—}03”, and “j2re1.4.2_{—}01” that each exist at the fourth level of a hierarchical file structure. The nodes can be files and/or directories. When the combo box 206 has focus, a user is allowed to select a node from among the three nodes that exist at the fourth level of the hierarchy using an input device, such as a keyboard or a mouse. As shown in the figure, a current selected node “j2re1.4.2_{—}05” can be presented in the text box portion of the combo box 206, while the remaining nodes at the same level of the tree structure “j2re1.4.2_{—}03” and “j2re1.4.2_{—}01” can be presented in the drop-down list portion of the combo box 206. Similarly, in the arrangement shown in FIG. 3, a user is allowed to the select from among the nodes existing a third level of the file structure using the spin box 306 when the control has focus. A user can either select a node using the spin box 306 control buttons or can type the name of a node existing at the third level of the hierarchy in the text box portion of the control 306.

In an alternative embodiment, a selection of a child of one of the nodes existing at the level of the tree structure represented by the selection component is allowed when the selection component has focus. For example, in the arrangement shown in FIG. 3, a user can be allowed to select the compound node “Java\j2re1.4.2_{—}05” using the spin box 306, eliminating the need to separately include the child node “j2re1.4.2_{—}05” in the displayed path. A user can be allowed to select from among particular children of the nodes existing at the current level of the hierarchy based on criteria, such as a relative recency of selection of the particular children, as discussed in greater detail below.

In block 108 of the method, only a selected node is displayed when the selection component does not have focus. What distinguishes a current or selected node in a selection control from the other selectable nodes included in the control can depend, among other things, on the type of selection control employed. As understood by those skilled in the art of computer science, selection components typically include configurable display attributes to indicate which, if any, of the items included in the components are the current and/or selected items. These attributes can include, among other things, visual cues such the foreground or background color of the current or selected item, the font or typeface of the current or selected item, and the relative position of the current item with respect to the other items included in the selection component.

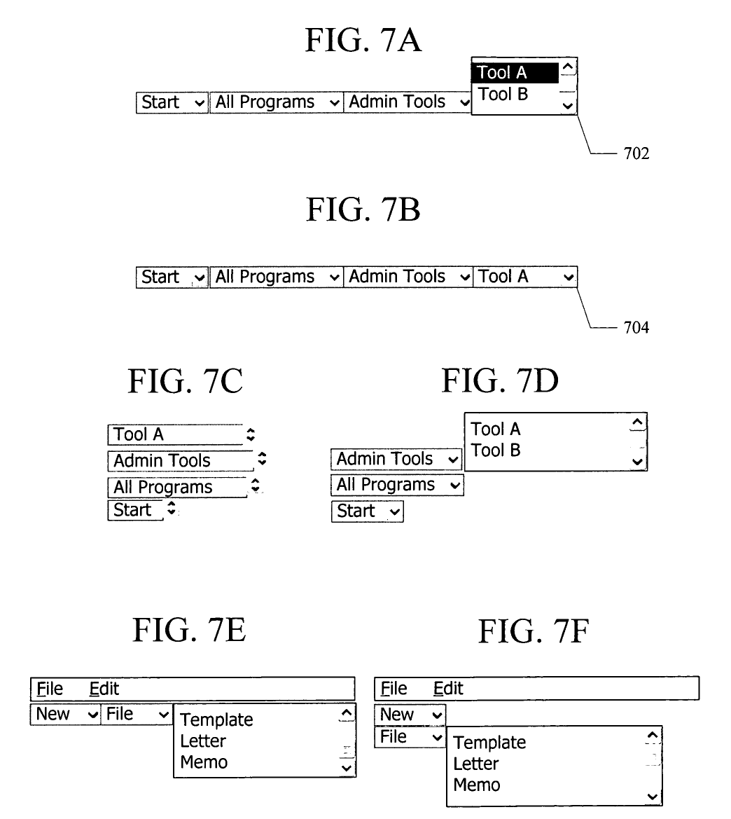

For example, in the illustrative arrangement shown in FIG. 7A, the open drop-down box 702, which has focus by the very nature of the control being open, includes two nodes “Tool A” and “Tool B” corresponding to files and/or directories in a hierarchical file structure. The node “Tool A” is presented in the open drop-down box 702 with a unique background color to indicate that the node is the currently selected node, while the remaining node “Tool B” is presented in the drop-down box 702 with no background color. Next, consider in the arrangement shown in FIG. 7B that the same drop-down box 704 no longer has focus. In the figure, the drop-down box 704 is shown to be closed and, according to the method, only the selected node “Tool A” is displayed in selection component 704. It should be understood in the above that the selection component not having focus and the selection component being closed can be mutually exclusive states.

The described method can provide for the displaying of a path to a node in a tree hierarchy in a relatively compact manner as compared to the larger form-factors associated with tree and menu views. For example, consider in FIG. 7A that several nodes exist at each of the levels represented in the displayed path by the drop-down boxes displaying the nodes “All Programs” and “Admin Tools”. When displaying the path to the node “Tool A” using a traditional menu view, all of the nodes existing at both the “All Programs” level and the “Admin Tools” level of the tree hierarchy will remain displayed on a computer monitor until the node “Tool A” is selected. Similarly, when displaying the path to the node “Tool A” using a tree view, all of the nodes existing at the “All Programs” level and the “Admin Tools” level will remain displayed on the computer monitor once expanded until a user closes the view, regardless of whether the node “Tool A” is selected or not. These display techniques can unnecessarily consume screen area that comes at a premium with today's portable electronic devices.

In contrast, by displaying only the selected node when the selection control does not have focus, the described method avoids displaying alternative paths through the tree structure that can unnecessarily consume screen area. For example, the configurations shown in FIGS. 7A and 7B require significantly less vertical screen area than that required using a traditional menu view. Moreover, replacing the drop-down boxes shown in these arrangements with spin boxes (not shown) would require a minimal amount of vertical screen area to display a path through the tree structure. An added benefit of using spin boxes as the selection component is their ability to be presented in a single line in the same manner that conventional paths are displayed, for example, in the location bar 302 of FIG. 3. The reduction in screen area over traditional menu views using the techniques described above can be even more dramatic when the number of nodes that exist at a particular level of the hierarchy require that the nodes be displayed in a multi-column menu view.

Similarly, the selection components can be arranged vertically on a display, as shown in FIG. 7C, to reduce the amount of horizontal screen area needed to display a path through the tree structure. The selection components can also be arranged in a staggered manner, as shown in FIG. 7D, to account for particular display requirements and/or special characteristics of the tree structure, for example, when the different levels in the tree structure have widely varying numbers of nodes. Finally, the techniques described above can be applied to emulate and enhance the operation of traditional drop-down menus, as shown in FIGS. 7E and 7F. Such arrangements can allow user interface designers to utilize drop-down menu-like controls for use on small-sized displays that otherwise would be unable to use such controls.

The described method also provides for the direct navigation via the selection component to another location at a same hierarchical level of tree structure (that is, the location of a sibling node) without the need to first navigate through the corresponding parent node. In contrast, the use of traditional folder views requires a user to reopen the parent node folder to navigate to and open the folder including the desired sibling. Moreover, use of the selection component requires no text entry to navigate to the new location, and the arrangements described above provide for a constant indication of the present location within the tree structure via the current node displayed in the selection component included in the displayed path.

According to an exemplary embodiment, a default action can be performed based on a type or an identity of the node when the node is selected using the selection component. The node can be selected in any number of ways known to persons skilled in the art. For example, the selection can occur in response to detecting a particular action from a pointing device, such as the “double-clicking” of a mouse button while a pointer is positioned over the current item. Alternatively, the selection can occur in response to detecting the activation of a particular keystroke on a keyboard, such as the activation of an “<ENTER>” or “<CTRL>+<ENTER>” keystroke while a cursor is active in the selection component.

When selected, the default action performed can be based on a type (for example, .EXE, .JPG, .MPG, and the like) of the node. For example, if the node is an executable file, the default action can be executing the application using a processor and memory. If, for example, the node is an image or video file, the default action can be launching an application to view the image or video file. If the selected node is not a leaf node—for example, if the selected node corresponds to a directory in a hierarchical file structure—the default action can be launching an application to view the contents of the node, such as WINDOWS EXPLORER. Alternatively, the default action can be based on the particular identity of the node, regardless of the node's type.

In another exemplary embodiment, when the node corresponding to the selected item is not a leaf node, the selection component can be included in the displayed path to represent a child of the node when the item is selected using the selection component. It can be advantageous to include a selection component in the displayed path to represent a child of the non-leaf node to provide for navigating to a location in the tree structure associated with the child node. As described briefly above, the selection component can be included in the displayed path by appending the selection component to a node identifier included in the path, along with any necessary delimiters such as a forward slash “\” or colon “:”.

The appending of the selection component can occur in response to a selecting of the current node displayed in the selection component. In this sense, the selection component can be said to “move” to the right (children are typically displayed to the right of a parent node in a path description) within the displayed path when the current node in the selection component is selected. In a first embodiment, the selection component is replaced in the displayed path with a node identifier corresponding to the selected current item, leaving a single selection component in the displayed path, as illustrated in FIGS. 2-6.

To illustrate this action, consider that the combo box 206 shown in FIG. 2 was appended to the node identifier “Java” in response to a user selecting the “Java” item included in the spin box 306 with a mouse. The spin box 306 shown in FIG. 3 could have been replaced with the node identifier “Java” shown in FIG. 2, resulting in the selection component appearing to “move” to the right in the displayed path. In a second related embodiment, a second selection component can be appended to the existing selection component in the displayed path to represent the child node, as illustrated in FIGS. 7A-7F. These techniques can provide for the non-linear navigation to any location in a tree structure in a relatively compact form-factor, as compared to tree, menu, and folder view tree structure representations, as discussed above.

In a related embodiment, a determination can be made whether the selected node has one or more children. If the selected node has more than one child, a default child node can be identified from among the determined children. The default child node can be displayed in the selection component or the second selection component when one or both of the components is included in the displayed path. For example, in the arrangement described in the paragraph above, each of the nodes “j2re1.4.2_{—}05”, “j2re1.4.2_{—}03”, and “j2re1.4.2_{—}01” can be determined to be children of the node “Java”. One of these nodes, for example, “j2re1.4.2_{—}05”, can be identified as the default node. The identified node “j2re1.4.2_{—}05” can be displayed in the text box portion of the combo box 206 to denote the node as the default child node. In addition, the default child node displayed in the selection component can include a reference to one of it's own children, for example the default child node could correspond to the sub-path “j2re1.4.2_{—}05\LICENSE.rtf”.

In yet other related embodiments, the default child node can be identified based on a recency of selection of the default child node using the selection component. For example, in the arrangement shown in FIG. 2, the child node corresponding to the item “j2re1.4.2_{—}05” may have been selected by a user most recently from among the other determined child nodes “j2re1.4.2_{—}03”, and “j2re1.4.2_{—}01”. The most-recently selected node “j2re1.4.2_{—}05” can be identified as the default child node and then displayed in the text box portion of the combo box 206 to denote the node as the default child node. Moreover, when the selected node is determined to have more than one child, the children can be included in the selection component or the second selection component in an order based on a recency of selection of each respective child node using the selection component. With these arrangements, a user can easily navigate to the more popular locations of a tree structure using a progression of selection components included in the displayed path by successively selecting—for example, by “double-clicking”—either the current nodes or the nodes presented near the top of an ordered list of nodes included in each of the selection components.

According to an exemplary embodiment, the contents of a node displayed in the selection component can be displayed. If the displayed node is a leaf node, the contents can be displayed in a content pane of a GUI window, such as the contents of the image file “Menu\Images\cars\mycar.jpg” shown in the content pane 504 of the GUI window 500 of FIG. 5. If, in the context of a hierarchical file structure, the displayed node is not a leaf node, an identifier of each child of the non-leaf node can be displayed in a content pane of a GUI window. For example, in the arrangement shown in FIG. 2, the content pane 204 of the GUI window 200 is shown to include identifiers (icons, file or directory names, and the like) for children of the node. Alternatively, the contents of the node can be displayed in a separate viewer or using a separate browsing application.

In a related embodiment, the contents can be displayed automatically when the node is displayed as a current selection in the selection component and when the selection component has focus. For example, in the arrangement shown in FIG. 2, the contents of either of the nodes “j2re1.4.2_{—}03” or “j2re1.4.2_{—}01” can be automatically displayed in the content pane 204 when the respective node identifier is displayed in the text box portion of the combo box 206 as the current selection. Under such circumstances, the combo box 206 would have focus. The automatic displaying of the node contents can occur, for example, in response to a user “single-clicking” a node included in the drop-down list portion of the combo box 206 shown in FIG. 2. This can then result in the “single-clicked” item being displayed as the current item in the text box portion of the combo box 206. Similarly, the automatic displaying can occur in response to a scrolling through the various items included in the spin box 306 shown in FIG. 3 using the “up” and “down” control buttons of the spin box 306.

In another related embodiment, the contents can be displayed when the displayed node is selected using the selection component. In this embodiment, a user can browse through the various sibling nodes at a particular level of the tree structure without displaying the contents of each sibling node. Instead, the contents of each sibling node need only be displayed when the current item is selected. As described above, a node can be selected by “double-clicking” the node identifier using a mouse, or perhaps by entering the keystrokes “<ENTER>” or “<CTRL>+<ENTER>” using a keyboard. In either this or the related embodiment described in the paragraph above, it is preferred (although not necessary) that nodes (or other selection components) displayed as child nodes of the selection component in the displayed path (those displayed to the right of the selection component) be removed before the displaying of the contents of a node occurs. Doing so can help to avoid confusion that may result if the location indicated by the displayed path does not coincide with the displayed contents of the currently selected node.

According to still other exemplary embodiments, the path including the selection component can be displayed in a location bar of a GUI and/or in a presentation space of the GUI as an identifier of a node in the tree structure. For example, FIGS. 2, 3, and 5 show the path including the selection component displayed in the location bars 202, 302, and 502 of their respective GUI windows 200, 300, and 500. Similarly, FIG. 4 shows the path including the selection component displayed in the content pane 404 of the GUI window 400 as an identifier 406 of the node “Local Disk” in the tree structure. In addition, FIG. 6 shows the path with the included selection component displayed in both the location bar 602 and in the content pane 604 of the GUI window 600 as an identifier 606 of the node “Cars” in the tree structure.

In a related embodiment, the contents of a node displayed in the selection component can be displayed in a portion of the presentation space adjacent to the path displayed as an identifier. When the node displayed in the selection component is an image or a video, any combination of an icon view, a thumbnail view, and a screennail view of the image or video can be displayed in the portion of the presentation space. For example, FIG. 4 shows a thumbnail view 408 of the image file “C:\MyStuff\photos\cars\mycar.jpg” displayed in the content pane 404 adjacent to the displayed path 402. Similarly, a screennail view 608 of the image file “Menu\Images\mycar.jpg” is displayed in the content pane 604 of the GUI window 600 shown in FIG. 6 adjacent to the displayed path 602. It will be understood that the phrase “adjacent to” used here can include arrangements in which the icon view, thumbnail view, or screennail view are displayed near, but not necessarily touching, the displayed path.

As described above, the displays of portable electronic devices, such as cameras, camera phones, and PDAs, are relatively small as compared to the displays typically used in conjunction with a PC. Accordingly, the path including the selection component can be displayed on more than one line of a graphical user interface to accommodate the smaller displays of these portable devices. Alternatively, the displayed path including the selection component can be scrolled across one line of a graphical user interface. These arrangements can provide for navigating to locations in complex tree structures using relatively small display devices.

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

FIG. 8 illustrates a system providing for the compact navigation of a tree structure according to an exemplary embodiment. While a preferred embodiment is described in connection with the portable electronic device 800 illustrated in FIG. 8, it will be understood that the techniques described here can be carried out using any electronic device having like components and circuitry, including, but not limited to, a PC, a television, a camera, an appliance, and the like.

The system 800 includes a tree structure, preferably stored in memory 802 of the system 800. The tree structure can be a hierarchical file system, such as an electronic photo album having sub-folders and corresponding image files, a hierarchical menu system, and the like. The system 800 also includes a display 804, a graphics subsystem 806 (depicted by a dashed box) coupled to the display 804, and an input subsystem 808 (depicted by a dashed box) coupled to the graphics subsystem 804.

The input subsystem 808 is operatively coupled to at least one input device, such as the keypad 810 or the mouse 812 shown in FIG. 8. In addition, the display 804 can be a touch-screen display capable of receiving input information via the input subsystem 808. Other pointing devices, such as a stylus or a light pen (neither shown) can be operatively coupled to the input subsystem 808 system and/or the display 804. In addition to the above, the system includes a processor (not shown) coupled to the memory 802, display 804, graphics subsystem 806, and input subsystem 808, for executing programmable instructions stored in the memory 802 for controlling the operation of the system 800. Actions performed by the graphics subsystem 806 and/or input subsystem 808 can be carried out, at least in part, using the processor.

The display is configured to display a path 814 in the tree structure. The graphics subsystem 806 is configured to include a selection component, such as the spin box 816 shown in FIG. 8, in the displayed path 814. As described above, the selection component is included in the displayed path to represent a level in the tree structure at which there exists more than one node. The graphics subsystem 806 is also configured to allow a selection of a node, such as the file “mycar.jpg” shown in FIG. 8, from among the nodes existing at the level of the tree structure when the selection component has focus. In addition, the graphics subsystem 806 is configured to display only a selected node when the selection component does not have focus. Examples and advantages of a system that displays only a selected node when the selection component does not have focus are described above in conjunction with FIGS. 7A-7F, and need not be repeated here.

The input subsystem 808 is configured to determine when the node is selected using the selection component 816. As described above, the input subsystem can determine that the item is selected by detecting a particular action from a pointing device, such as the “double-clicking” of a mouse button 818 while a pointer (not shown) is positioned over the current item. Alternatively, the selection can occur in response to detecting the activation of a particular keystroke on a keypad 810, such as the activation of a “<SEND>” keystroke while a cursor 818 is active in the selection component. In addition, the input subsystem 808 is configured to determine, in conjunction with the graphics subsystem 806, whether the selection component has focus of an input device or not.

As described above in conjunction with the related method, the system 800 can be configured to perform a default action based on a type or an identity of the node when the input subsystem determines that the node is selected using the selection component. For example, if the node is an image or video file, such as the image file “mycar.jpg” shown in FIG. 8, the default action can be displaying the image or video file, or a representation thereof, on the display 804. As shown in FIG. 8, the image file 822 can be displayed on the display 804 in response to the selection of the node “mycar.jpg”. The default action can be carried out by the processor (not shown) executing instructions stored in the memory 802.

According to an exemplary embodiment, when the selected node is not a leaf node, the graphics subsystem can be configured to include the selection component or a second selection component in the displayed path to represent a child of the selected node. As described above, the selection component can be included in the displayed path by appending the selection component to a node identifier included in the path, along with any necessary delimiters such as a forward slash “\” or colon “:”. For example, in the system shown in FIG. 8, the spin box 816 could have been appended to the node identifier “cars” to represent that the node “mycar.jpg”, displayed in the spin box 816, is a child node of the node “cars”. These techniques are described above in greater detail in connection with the arrangements shown in FIGS. 2 and 3.

In a related embodiment, the system can be configured to determine whether the selected node has one or more children and to identify a default child node from among any such determined children. The processor can make such a determination by performing, for example, a tree search algorithm on the hierarchical data stored in the memory 802. The graphics subsystem can be configured to display the default child node in the selection component or the second selection component when included in the displayed path. Again, these techniques are described above in connection with the arrangements shown in FIGS. 2 and 3, and need not be repeated here.

In yet another related embodiment, the system can be configured to identify the default child node based on a recency of a selection of the default child node using the selection component. The processor can store the relative times when the various sibling nodes at a given level of the tree structure are selected in the memory 802. The processor can then access this information in determining the identity of the default child node. Preferably, the default child node corresponds to the child node selected most recently using the selection component.

In still another related embodiment, when the selected node is determined to have more than one child, the graphics subsystem can be configured to include the children in the selection component in an order based on a recency of selection of each respective child node using the selection component. The order of the items can be determined by the processor and communicated to the graphics subsystem 806 for inclusion in the selection component. This technique is described above in greater detail in conjunction with the arrangement of FIG. 2, which shows various sibling nodes included in an order in the open combo box 206.

According to an exemplary embodiment, the graphics subsystem can be configured to display the contents of a node displayed in the selection component on the display. The graphics subsystem can be configured to automatically display the contents on the display when the node is displayed as a current selection in the selection component and when the input subsystem 808 determines the selection component has focus. For example, the contents of the image file 822 corresponding to the current item “mycar.jpg” is shown in the display 804 of FIG. 8. To achieve this operation, the input subsystem 808 can first detect that a control button on the spin box 816 has been activated and can then communicate this activation to the graphics subsystem 806. In response, the graphics subsystem 806 can update the node displayed as the current selection in the spin box 816 and then automatically display the contents of the node corresponding to the updated current selection without user intervention. Alternatively, the graphics subsystem 806 can be configured to display the contents on the display 804 when the input subsystem 808 determines that the displayed node is selected using the selection component. A node can be selected, for example, by “double-clicking” the current selection displayed in the selection component using the mouse button 818.

As described above, the path including the selection component can be displayed on the display in a location bar of a GUI and/or a presentation space of the GUI as an identifier of a node in the tree structure. In addition, the graphics subsystem can be configured to display the contents of a node displayed in the selection component in a portion of the presentation space adjacent to the path displayed as an identifier. Moreover, when the node displayed in the selection component is an image or a video, the graphics subsystem can be configured to display at least one of an icon view, a thumbnail view, and a screennail view of the image or video in the portion of the presentation space. It will be understood that any of the arrangements shown in FIGS. 2-6, as described in greater detail above, can be displayed on the display 804 of the system 800 shown in FIG. 8.

According to another exemplary embodiment, the graphics subsystem can be configured to display the path including the selection component on more than one line of a graphical user interface. In addition, the graphics subsystem can be configured to scroll the path across one line of a graphical user interface. For example, the system 800 shown in FIG. 8 includes scroll buttons 824 arranged in a portion of the display 804 where the path 814 is displayed. The scroll buttons 824 can be displayed by the graphics subsystem 806 when the length of displayed path, including the selection component 816, is greater than the width of the display 804. As shown in FIG. 8, a portion of the displayed path 814, for example, “C:\My Documen” is not shown in the display 804 (only the portion “ts” of the node identifier “Documents” is shown). A user can scroll the displayed path 814 to view hidden portions thereof by “dragging” the path left or right using the mouse 812.

The executable instructions of a computer program as illustrated in FIG. 1, providing for the compact navigation of a tree structure, can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method providing for the compact navigation of a tree structure, the method comprising:
displaying a path in the tree structure;
including a selection component in the displayed path to represent a level of the tree structure at which there exists a plurality of nodes;
allowing a selection of a node from among the plurality of nodes when the selection component has focus; and
displaying only a selected node when the selection component does not have focus.

2. The method of claim 1, comprising:
performing a default action based on a type or an identity of the node when the node is selected using the selection component.

3. The method of claim 1, wherein when the selected node is not a leaf node, the method comprises:
including the selection component or a second selection component in the displayed path to represent a child of the selected node.

4. The method of claim 3, comprising:
determining whether the selected node has one or more children;
identifying a default child node from among any determined children; and
displaying the default child node in the selection component or the second selection component when included in the displayed path.

5. The method of claim 4, wherein the default child node is identified based on a recency of selection of the default child node using the selection component.

6. The method of claim 4, wherein when the selected node is determined to have more than one child, the method comprises:
including the children in the selection component or in the second selection component in an order based on a recency of selection of each respective child node, wherein the default child node corresponds to a most-recently selected child node.

7. The method of claim 1, comprising:
displaying the contents of a node displayed in the selection component.

8. The method of claim 7, wherein the contents are displayed automatically when the node is displayed as a current selection in the selection component and the selection component has focus.

9. The method of claim 7, wherein the contents are displayed when the displayed node is selected using the selection component.

10. The method of claim 1, wherein the path including the selection component is displayed in at least one of a location bar of a graphical user interface (GUI) and a presentation space of the GUI as an identifier of a node in the tree structure.

11. The method of claim 10, comprising:
displaying the contents of a node displayed in the selection component in a portion of the presentation space adjacent to the path displayed as an identifier.

12. The method of claim 11, wherein when the node displayed in the selection component is an image or a video, at least one of an icon view, a thumbnail view, and a screennail view of the image or video is displayed in the portion of the presentation space.

13. The method of claim 1, comprising:
displaying the path including the selection component on more than one line of a graphical user interface.

14. The method of claim 1, comprising:
scrolling the path including the selection component across one line of a graphical user interface.

15. The method of claim 1, comprising:
allowing a selection of a child of one of the plurality of nodes when the selection component has focus.

16. A system providing for the compact navigation of a tree structure, the system comprising:
a display configured to display a path in the tree structure;
a graphics subsystem coupled to the display, wherein the graphics subsystem is configured to include a selection component in the displayed path to represent a level of the tree structure at which there exists a plurality of nodes, to allow a selection of a node from among the plurality of nodes when the selection component has focus, and to display only a selected node when the selection component does not have focus; and
an input subsystem coupled to the graphics subsystem, wherein the input subsystem is configured to determine when the node is selected using the selection component and whether the selection component has focus.

17. The system of claim 16, wherein the system is configured to perform a default action based on a type or an identity of the node when the node is selected using the selection component.

18. The system of claim 16, wherein when the selected node is not a leaf node, the graphics subsystem is configured to include the selection component or a second selection component in the displayed path to represent a child of the selected node.

19. The system of claim 18, wherein the system is configured to determine whether the selected node has one or more children and to identify a default child node from among any determined children, and the graphics subsystem is configured to display the default child node in the selection component or the second selection component when included in the displayed path.

20. The system of claim 19, wherein the system is configured to identify the default child node based on a recency of a selection of the default child node using the selection component.

21. The system of claim 19, wherein when the selected node is determined to have more than one child, the graphics subsystem is configured to include the children in the selection component or in the second selection component in an order based on a recency of selection of each respective child node, wherein the default child node corresponds to a most-recently selected child node.

22. The system of claim 16, wherein the graphics subsystem is configured to display the contents of a node displayed in the selection component.

23. The system of claim 22, wherein the graphics subsystem is configured to automatically display the contents on the display when the node is displayed as a current selection in the selection component and when the input subsystem determines the selection component has focus.

24. The system of claim 22, wherein the graphics subsystem is configured to display the contents on the display when the input subsystem determines that the displayed node is selected using the selection component.

25. The system of claim 16, wherein the path including the selection component is displayed on the display in at least one of a location bar of a graphical user interface (GUI) and a presentation space of the GUI as an identifier of a node in the tree structure.

26. The system of claim 16, wherein the graphics subsystem is configured to display the contents of a node displayed in the selection component in a portion of the presentation space adjacent to the path displayed as an identifier.

27. The system of claim 26, wherein when the node displayed in the selection component is an image or a video, the graphics subsystem is configured to display at least one of an icon view, a thumbnail view, and a screennail view of the image or video in the portion of the presentation space.

28. The system of claim 16, wherein the graphics subsystem is configured to display the path including the selection component on more than one line of a graphical user interface.

29. The system of claim 16, wherein the graphics subsystem is configured to scroll the path including the selection component across one line of a graphical user interface.

30. The system of claim 16, wherein the graphics subsystem is configured to allow a selection of a child of one of the plurality of nodes when the input subsystem determines that the selection component has focus.

31. A computer readable medium containing a computer program providing for the compact navigation of a tree structure, the computer program comprising executable instructions for:
displaying a path in the tree structure;
including a selection component in the displayed path to represent a level of the tree structure at which there exists a plurality of nodes;
allowing a selection of a node from among the plurality of nodes when the selection component has focus; and
displaying only a selected node when the selection component does not have focus.

32. The medium of claim 31, wherein the computer program comprises executable instructions for:
performing a default action based on a type or an identity of the node when the node is selected using the selection component.

33. The medium of claim 31, wherein when the selected node is not a leaf node, the computer program comprises executable instructions for:
including the selection component or a second selection component in the displayed path to represent a child of the selected node.

34. The medium of claim 33, wherein the computer program comprises executable instructions for:
determining whether the selected node has one or more children;
identifying a default child node from among any determined children; and
displaying the default child node in the selection component or a second selection component when included in the displayed path.

35. The medium of claim 31, wherein the computer program comprises executable instructions for:
displaying the contents of a node displayed in the selection component.

36. The medium of claim 35, wherein the executable instructions automatically display the contents when the node is display in the selection component and the selection component has focus.

37. The medium of claim 35, wherein the executable instructions display the contents when the displayed node is selected using the selection component.

38. The medium of claim 31, wherein the executable instructions display the path including the selection component in at least one of a location bar of a graphical user interface (GUI) and a presentation space of the GUI as an identifier of a node in the tree structure.

39. The medium of claim 38, wherein the executable instructions display the contents of a node displayed in the selection component in a portion of the presentation space adjacent to the path displayed as an identifier.

40. The medium of claim 31, wherein the computer program comprises executable instructions for:
scrolling the path including the selection component across one line of a graphical user interface.
